(19) United States
(12) Patent Application Publication
(10) Pub. No.: US 2025/0262805 A1
(43) Pub. Date: Aug. 21, 2025

(54) HOLLOW INTERCONNECTING BLOCK MOLDS

(71) Applicant: William Gerard Donnelly, Barrington, NH (US)

(72) Inventor: William Gerard Donnelly, Barrington, NH (US)

(21) Appl. No.: 18/581,494

(22) Filed: Feb. 20, 2024

(51) Int. Cl. B29C 33/30

(52) U.S. Cl. CPC B29C 33/301

(57) ABSTRACT

This disclosure provides hollow interconnecting block molds with outward protrusions that affix together to build structures, walls, foundations, floors, buildings, flotation devices, gardening structures, artificial coral reefs, or toys. The hollow interconnecting block molds comprises an interior hollow center space surrounded by the interior faces, a uniform wall thickness between the interior and exterior faces exists, wherein mechanical hardware installed through the connecting outward protrusions will not interfere with the clear passageways of the center outward protrusions. The center outward protrusions have a diameter large enough for human hands to enter into the interior hollow center spaces of two proximate block molds, for manipulating mechanical hardware in and around to pass threaded rod through the outward protrusion of the two block molds to affix them together. The center outward protrusions allow for materials such as pipes, wires, conduit, and rebar to pass through two or more block molds.

### PRIORITY

This application claims priority to U.S. Non-Provisional application Ser. No. 18/401,476, filed Dec. 30, 2023 and titled, “HOLLOW INTERCONNECTING PRISM BLOCKS,” and this application also claims priority to U.S. Provisional Application No. 63/447,221, filed Feb. 21, 2023 and titled, “HOLLOW INTERCONNECTING BLOCK MOLDS,” and this application also claims priority to U.S. Provisional Application No. 63/436,563, filed Dec. 31, 2022 and titled “HOLLOW INTERCONNECTING PRISM BLOCKS,” and this application also claims priority to U.S. Non-Provisional application Ser. No. 17/505,876—Docket No. DON. 100CON, filed Oct. 20, 2021, U.S. Non-Provisional application Ser. No. 17/067,619—filed Oct. 9, 2020, U.S. Provisional Application No. 62/912,979, filed Oct. 9, 2019 and titled “INTERLOCKING BLOCKS MOLDS,” and this application also claims priority to U.S. Non-Provisional application Ser. No. 16/155,990—Docket No. DON. 100UTI, filed Oct. 10, 2018, and International Application No. PCT/US18/55139—Docket No. DON. 100PCT, filed: Oct. 10, 2018, and titled “INTERLOCKING BLOCKS,” and this application also claims priority to U.S. Provisional Application No. 62/577,917, filed Oct. 27, 2017 and titled “INTERLOCKING RECTANGULAR PRISM BLOCKS CONNECTING BUILDING STRUCTURES” and to U.S. Provisional Application No. 62/577,633, filed Oct. 26, 2017 and titled “INTERLOCKING TRAPEZOIDAL PRISM BLOCKS CONNECTING BUILDING STRUCTURES,” all of which applications are incorporated herein by reference in their entireties.

### FIELD

This disclosure relates to hollow interconnecting block molds. More specifically, this disclosure relates to hollow interconnecting block molds for use in construction, gardens, flotation, and a variety of other uses.

### BACKGROUND

Presently, hollow interconnecting block molds do not have a specific wall thickness with an interior hollow center space inside the hollow interconnecting block molds, with the interior hollow center space comprising the same dimensions as the body of the mold's outside dimensions, but of a smaller size to account for the wall thickness of the faces of the mold, having face center outward protrusions in the center area of each face of the hollow interconnecting block molds, allowing human hands and/or specialized tools to enter into the hollow interior center space through the center outward protrusions, to affix the two molds together, by manipulating mechanical hardware inside of the interior hollow center space via the connecting outward protrusions of the adjacent molds, whereas the molds become interconnected together, with the mechanical hardware remaining inside of the interior hollow center spaces of each mold, and have the capability to be affixed together from the parallelogram faces with outward protrusions, the top end base face with outward protrusions, and the bottom end base face with outward protrusions, of each faces of the mold having the same proximate size and shape and same proximate outward protrusion patterns, allowing materials such as rebar, pipes, conduit and other materials to pass through the center outward protrusions of the faces and through the interior hollow center spaces of the bodies of all the molds, before, during, or after they are affixed together.

Current hollow interconnecting block molds lack the ability to be assembled together while in outer space, while floating on water, or be assembled together while under water, nor can current block molds be physically mounted to existing seawalls to produce structures that could provide sufficient strength and height to prevent rising sea waters from breaching the walls, with the ability to have plumbing pipes, electrical conduit, electrical wires, rebar, and other desired materials, comprised of either solids, liquids, gasses, or plasma, installed within the wall structure of the molds during and after construction of the desired structure.

With oceans and coastal waters continuing to rise, governments and municipalities around the world need to reinforce existing walls, build new walls, and engineer additional solutions to prevent incoming water from destroying waterfront structures and localities.

A major drawback of existing wall systems, is the existing hollow interconnecting block molds inability to be joined together from the outward protrusions on all faces by additional hollow interconnecting block molds from within their interior hollow center spaces and to be securely affixed to another hollow interconnecting block mold or to affixed to an existing structure, by accessing the interior hollow center space from the face center outward protrusions of each of the molds and by using mechanical hardware to affix the molds together via their connecting outward protrusions from within the hollow void areas of the hollow interconnecting block molds, nor can existing hollow interconnecting block molds be affixed together with hollow connector pipes being glued, fused, or affixed to the ends of the outward protrusions on the faces of the faces of the molds, allowing two or more hollow interconnecting block molds to be affixed together, with the ability for pipes, conduit, rebar, wires, or other materials to pass through the center outward protrusions of the structure built with hollow interconnecting block molds after the structure has been built, without the need to disassemble the structure, drill holes, nor to modify the structure in any way.

A second major drawback of current hollow interconnecting block molds is the inability to pass materials such as rebar, pipes, wire, conduit, etc. through two or more connected hollow interconnecting block molds, allowing the materials to enter into the interior hollow center spaces of the hollow interconnected block molds, so that the materials can pass through the structure built with hollow interconnecting block molds, and may allow materials to pass in different directions throughout the hollow interconnecting block mold structure through the face center outward protrusions on each face of the hollow interconnecting block mold.

A third major drawback of existing hollow interconnecting block molds is the inability for the hollow interconnecting block molds to filled with desired materials and/or strengthening materials to form one continuous and solid structure from all of the hollow interconnecting block molds having been previously affixed together with mechanical hardware via the face interconnecting outward protrusions or and/or with connector pipes becoming affixed and/or glued to the exterior ends of the faces center outward protrusions and exterior ends of the faces connecting outward protrusions of each face of the hollow interconnecting block molds, to fulfill a desired purpose, such as to create structures and block molds for building seawalls, garden wall structures, vertical gardens, floating gardens, other floatation structures, artificial coral reefs, or other desired purposes.

A need exists for improved hollow interconnecting block molds to be used for producing interconnecting blocks and structures for retaining walls, sea walls, foundations, water-capturing garden block molds and structures, vertical gardens, buildings, artificial reefs, and other applications.

### SUMMARY

Hollow interconnecting block molds have at least three parallelogram faces and two ends. The ends of the hollow interconnecting block molds are sometimes referred to as bases. In this disclosure the bases may be referred to as a top end or a bottom end base exterior face, or end faces. In some instances, a hollow interconnecting block mold is said to have four faces plus the bottom end base exterior face and top end base end. At least two faces of each hollow interconnecting block mold each comprises one face center outward protrusion and at least one face connecting outward protrusion, between the at least three parallelogram faces, the top end base face, and the bottom end base face.

The bases could be triangle, square, rectangle, or any number of faces. For example, a pentagonal hollow interconnecting block mold has two pentagonal end base faces and five parallelogram faces. In one aspect, this disclosure provides hollow interconnecting block molds comprising at least five faces, wherein comprising at least three or more parallelogram faces, one top end base face, and one bottom end base face, a minimum of six vertices and a minimum of nine edges, wherein at least two faces of the hollow interconnecting block molds comprise a face center outward protrusion around the center of the face and comprise at least one face connecting outward protrusion on each face comprising a face center outward protrusion.

In further embodiments, a hollow interconnecting block mold comprises one or more face edge outward protrusions proximate to one or more of the face edges.

In still yet further embodiments, a hollow interconnecting block mold comprises one or more face vertex outward protrusions proximate to one or more of the face vertices.

Yet another aspect of this disclosure is directed to a hollow interconnecting block mold structure, comprising a plurality of hollow interconnecting block molds, wherein each hollow interconnecting block mold comprises five or more faces, and wherein each face comprises a center outward protrusion and a plurality of interconnecting outward protrusions, wherein the plurality of hollow interconnecting block molds are connected by mechanical hardware via the connecting outward protrusions, wherein a plurality of the center outward protrusions are aligned whereas connecting outward protrusions become aligned.

In yet a further aspect of this disclosure is directed to a hollow interconnecting block mold structure, comprising a plurality of hollow interconnecting block molds, wherein each hollow interconnecting block mold comprises five or more faces, and wherein each face comprises a center outward protrusion and a plurality of connecting outward protrusions, wherein the plurality of hollow interconnecting block molds are connected by hollow connector pipes being glued, fused, welded, and or connected to the exterior walls of the ends of the connecting outward protrusions and ends of the face center outward protrusions, wherein a plurality of the connecting outward protrusions and center outward protrusions are aligned, wherein mechanical hardware may also be used via the connecting outward protrusions, for additional securement, while the couplings or pipes glued/affixed to and around the ends of the connecting outward protrusions and the face center outward protrusions help prevent undesirable materials to enter into interior hollow center spaces of the hollow interconnecting block molds. Caps or rim membranes installed over or to the rims of the outward protrusions may also protect the interior hollow center spaces of the block mold.

In some embodiments, the hollow interconnecting block mold produces a hollow interconnecting block mold structure, by affixing together hollow interconnecting block molds, whereas the hollow interconnecting block mold structure may be sealed then have the block mold structure be encapsulated by self-hardening liquified cement, or be filled with a material or a combination of materials, such as self-eroding hardened food material for making ocean reefs for animal and plant life, or for building structures to help protect the shorelines from eroding, by using materials such as self-hardening liquified cementitious materials poured into the face center outward protrusion of the top end face of one or more hollow interconnecting block molds, to fill the interior hollow center spaces of each and every one of the hollow interconnecting block molds, as their face center outward protrusions are in proximate alignment, whereas the self-hardening liquified cementitious materials pass through the face center outward protrusions to an adjacent and affixed hollow interconnecting block molds through the length, width, and height of the structure, with the materials being administered into the mold structure encompassing each and every portion of the interior hollow center spaces and hollow outward protrusions, until the entire structure has been completely filled in one pour, to produce the strongest possible structure, while in other embodiments the block mold structure remains hollow and void of cementitious materials but may be filled with pipes, conduits, wires, and rebar, wherein the body and outward protrusions of the mold or connected molds are encapsulated with solidifying materials such as liquified self-hardening cementitious materials.

### BRIEF DESCRIPTION OF THE FIGURES

FIG. 1 depicts a three-dimensional view of an embodiment of a hollow interconnecting block mold 1000 having four parallelogram faces, one bottom end base face and one top end base face, with one center outward protrusion on each of the six faces and four connecting outward protrusions proximate each vertex on each of the six faces, whereas all of the outward protrusions extend from the exterior faces of the molds structure to the rim at the end of each outward protrusion, wherein each rim may or may not be affixed with a rim membrane to prevent deleterious materials from entering inside to the interior hollow center space body of the mold.

FIG. 2 depicts a three-dimensional view of an embodiment of two hollow interconnecting block molds 1000 proximate each other and becoming assembled together with mechanical hardware, securing the molds together with the threaded rod passing through the connecting outward protrusions and through the washers, and nuts becoming affixed to each end of the threaded rod, wherein assembly of the mechanical hardware connecting the block molds continues inside the interior hollow center space of each of the two molds, wherein a faceplate is becoming physically attached to the mold with threaded rods, washers, and nuts, and rim membranes are affixed to the top end base face outward protrusion rims.

FIG. 3 depicts a three-dimensional view of an embodiment of thirty hollow interconnecting block molds 1000 assembled together with mechanical hardware, with plastic pipes, metal wires, metal pipes, and rebar passing through the structure, through the length, width, and height of the structure. Twenty-four hollow interconnecting block molds are visible.

FIG. 4 depicts a three-dimensional view of an embodiment of one plastic hollow interconnecting block mold having five faces, comprised of three parallelogram faces, a top end base face, and a bottom end base face.

FIG. 5A depicts a three-dimensional view of the process of manufacturing a hollow interconnecting block mold 1000 comprised of six faces by assembly, whereas the six sides of the block mold are separated.

FIG. 5B depicts the six sides of the block mold 1000 displaying the exterior faces having outward protrusions and have moved closer into alignment for assembly, whereas the faces are becoming closer in proximity to each other for assembly.

FIG. 5C depicts the faces of block mold 1000 having been assembled together with six faces, 12 edges, 8 vertices affixed together, comprising one center outward protrusion and four connecting outward protrusions on each face.

FIG. 6A depicts block mold 1000, from FIG. 1, is in the process to be used to manufacture a hollow interconnecting block, whereas it will be secured in a container then encapsulated by liquified self-hardening cementitious materials.

FIG. 6B depicts a transparent container to be used to manufacture a hollow interconnecting block from block mold 1000.

FIG. 6C depicts block mold 1000 secured inside the transparent container, with all of the outward protrusion rims affixed with rim membranes, as the protected rims fit snuggly inside the transparent container.

FIG. 6D depicts liquified self-hardening cementitious materials encapsulating block mold 1000.

FIG. 6E depicts a hollow interconnecting block manufactured by encapsulating a hollow interconnecting block mold 1000 in cement.

FIG. 7A depicts block mold 1000, from FIG. 1, connected to another block mold 1000 with pipes and couplings.

FIG. 7B depicts block mold 1000, from FIG. 1, in a configuration of four block molds connected together with PVC couplings connecting the outward protrusions together.

### DETAILED DESCRIPTION

This disclosure provides hollow interconnecting block molds that can be made of a variety of materials and have a variety of applications. More specifically, this disclosure provides hollow interconnecting block molds that can be connected together mechanically from inside the interior hollow center space, from the outward protrusions on each face of hollow interconnecting block molds, and/or connected together with mechanical unions, or by multiple ways, including gluing hollow pipes or couplings to the inside or outside the outward protrusions of the face center outward protrusions and face connecting outward protrusions of a first block mold and connecting the open ends of the pipes to the outward protrusions of a second block mold or object.

As used herein, the term “and/or” includes any and/or all combinations of one or more of the associated items. As used herein, the terms “a”, “an”, and “the” mean one or more, unless contextually or specifically indicated otherwise. As used herein, the term “about” means+/−10% of a stated value. As used herein, the term “end face or end faces”, or the term “end base face or end base faces”, or the term “base or bases”, or the term “top end base face or bottom face” or the term “top end base face or bottom end base face” refer to the face or faces of the hollow interconnecting block mold that may or not be parallelograms. As used herein, the term “molds” and “mold” or the term “block molds” and “block molds” refer to the hollow interconnecting block mold. As used herein, the term “faces” and “face” refer to the exterior portion of the faces or face of the hollow interconnecting block mold, whereas each face is comprised of an exterior face with a wall thickness between the exterior face and the interior face, whereas outward protrusions may extend only from exterior faces of these hollow interconnecting block molds of this disclosure. The interior face will be specifically identified as the interior face, when it becomes necessary and relevant to specify matters relating to the interior faces located inside the interior hollow center space.

As the climate on the Earth continues to change and sea levels continue to rise, stronger and higher retaining walls, seawalls, and other structures are needed to protect coastal communities. The hollow interconnecting block molds of this disclosure can be used to build stronger and taller retaining walls and seawalls that can be filled with fortifying materials, wherein the molds can also be used to manufacture hollow interconnecting block molds, structures, and foundations for earth and vegetation, to protect and produce salt marshes and mangroves, watersheds and drainage basins, and gardens for indigenous plants, eatable plants, and/or places for animals to thrive. The design of the hollow interconnecting block mold allows for objects to be passed through the face center outward protrusions of the hollow interconnecting block molds before filling the hollow interconnecting block molds or encapsulating the molds with material(s). For example, metal pipes, plastic pipes, electrical wires, conduit, rebar, insulation, and other materials can be passed through the face outward protrusions of one or more of the connected hollow interconnecting block molds prior to filling the hollow interconnecting block mold structure with fortifying material(s), or encapsulating the hollow interconnecting block mold structure, if desired. Walls created with hollow interconnecting block molds manufactured with the aforementioned hollow interconnecting block molds of this disclosure are unlike any other walls in previous existence.

This disclosure provides methods to manufacture hollow interconnecting block molds and structures. Each hollow interconnecting block mold has a number of faces that are parallelogram faces, and two end faces also known as the top end face and the bottom end base face or top end base face and bottom end base face or top end base exterior face and bottom end base exterior face, or top end base and bottom end base, whereas the two end faces comprise at least three vertices with face center outward protrusions and at least three face connecting outward protrusions on the faces designed to have outward protrusions.

Although hollow interconnecting block molds have walls on all sides and outward protrusions on exterior faces designed to have outward protrusions, the walls of the hollow interconnecting block molds also have interior faces requiring to be identified, whereas during the act of assembling block molds to block molds, threaded rods, nuts, and washers brought into the interior hollow center space will be manipulated to allow threaded rod to enter into the outward protrusion of the first block mold then through the outward protrusion of the second block mold, wherein each end of the threaded rod would pass through the washers, whereas the nuts would be wound on to each and then be tightened snuggly to physically connect the block molds together. Hollow interconnecting block molds comprise exterior faces which may or may not have outward protrusions, whereas exterior faces may also be known as being referenced as “face or faces”, wherein the interior of the hollow interconnecting block mold has interior faces, whereas interior faces will be specifically identified as “interior face or interior faces”, for which the interior hollow center space is contained within the confines of the interior faces of each hollow interconnecting block mold.

Unlike existing hollow interconnecting block molds, any face of the hollow interconnecting block molds with interconnecting outward protrusions of this disclosure can be connected to another hollow interconnecting block mold with outward protrusions of the same configuration or can be physically mounted to an existing structure. In other words, hollow interconnecting block molds of this disclosure can be connected on any parallelogram face, any top end base face. or any bottom end base face of any hollow interconnecting block molds of the same face configuration of outward protrusions.

Embodiments of the hollow interconnecting block molds have at least two faces that have face center outward protrusions and face connecting outward protrusions.

In some embodiments, the hollow interconnecting block mold has three parallelogram faces (referred to herein as “triangular”) and two end faces. The “end faces” refer to faces of the hollow interconnecting block mold on the top end base face and bottom end base face of the mold. In other embodiments, the hollow interconnecting block mold has four parallelogram faces (may be referred to as “rectangular” when appropriate) and two end faces, wherein the two end faces are also known as the top end base face and the bottom end base face. In further embodiments, the hollow interconnecting block mold has five parallelogram faces (referred to as “pentagonal”) and two end faces. In additional embodiments, the hollow interconnecting block mold has six parallelogram faces with outward protrusions (referred to as “hexagonal”) and two end faces. In still further embodiments, the hollow interconnecting block mold has more than six parallelogram faces and has two end faces, whereas end faces are also known as bases, wherein any and all of the embodiments of the hollow interconnecting block molds have at least two faces that each have one face center outward protrusion and at least one face connecting outward protrusion.

Each parallelogram face of a hollow interconnecting block mold comprises four vertices and four edges. Two or more faces, and/or end faces of a hollow interconnecting block mold comprise a center outward protrusion proximate its center and a connecting outward protrusion proximate its edge or vertex. In some embodiments, the end faces of a hollow interconnecting block mold comprise three or more vertices and three or more edges. In some embodiments, one end face or both end faces of a hollow interconnecting block mold comprise a center outward protrusion around its center. In some embodiments, each center outward protrusion on a face aligns with the center outward protrusion on the opposite face. In some embodiments, one or more connecting outward protrusions are located proximate to each vertex of each face. In some embodiments, one or more edge connecting outward protrusions are located proximate to the middle of one or more edges of the faces. The orientation and location of the vertex connecting outward protrusions and edge connecting outward protrusions varies. In some embodiments, the center outward protrusion, vertex connecting outward protrusion, or edge connecting outward protrusion is round. In other embodiments, the center outward protrusion, vertex connecting outward protrusion, or edge connecting outward protrusion is not round.

In some embodiments, all of the faces and end faces of a hollow interconnecting block mold comprise a center outward protrusion. In other embodiments, all of the faces and end faces of a hollow interconnecting block mold comprise a center outward protrusion and one or more connecting outward protrusions. In further embodiments, some faces and/or some end faces have center outward protrusions, or connecting outward protrusions, or both. In some embodiments, one face or one end face of the hollow interconnecting block mold has no center outward protrusion and no connecting outward protrusions. In other embodiments, two faces of the hollow interconnecting block mold have no center outward protrusion and no connecting outward protrusions. In further embodiments, one face and one end face of the hollow interconnecting block mold have no center outward protrusion and no connecting outward protrusions. In still further embodiments, three faces of the hollow interconnecting block mold have no center outward protrusion and no connecting outward protrusions. In yet further embodiments, one face and two end faces of the hollow interconnecting block mold have no center outward protrusion and no connecting outward protrusions. In additional embodiments, two faces and one end face of the hollow interconnecting block mold have no center outward protrusion and no connecting outward protrusions. In some embodiments, four faces of the hollow interconnecting block mold have no center outward protrusion and no connecting outward protrusions. In some embodiments, two faces and two end faces of the hollow interconnecting block mold have no center outward protrusion and no connecting outward protrusions. In some embodiments, three faces and one end face of the hollow interconnecting block mold have no center outward protrusion and no connecting outward protrusions.

The center outward protrusions allow materials to pass through the hollow interconnecting block mold's interior hollow center space and through the interior hollow center outward protrusions, in different directions, through the center outward protrusions on the block mold to either the interior hollow center space of an adjacent block mold though the face center outward protrusion or pass to the free air, with the number of possible directions depending on the number of faces that particular hollow interconnecting block mold has. The center outward protrusions also allow hollow interconnecting block molds to be filled with material(s) or choose to allow the interior of the hollow interconnecting block molds to remain hollow. For example, multiple hollow interconnecting block molds could be connected together and then filled with sand, concrete, mud, rocks, gravel, water, insulation, gaseous materials, fluids, plasma, flotation materials, etc., or the hollow interconnecting block mold would remain with a hollow interior. A hollow interconnected block mold structure comprised of plastic materials, with the inside of the interior hollow center space comprised of foam insulation, may be designed to float on water.

In some embodiments, the surfaces of the faces of a hollow interconnecting block mold are flat and have outward protrusions. In some embodiments, the surfaces of the faces of a hollow interconnecting block mold are smooth and have outward protrusions. In other embodiments, one or more surfaces of a hollow interconnecting block mold are rough and have outward protrusions. In further embodiments, one or more surfaces of a hollow interconnecting block mold comprises a nonslip coating, bumps, ridges, or grooves and have outward protrusions.

The hollow interconnecting block mold can be made of any suitable material, depending on the application of the block mold and the structure being constructed. Strong, consistent materials with a high load carrying ability and resistant to stresses can be used to make the hollow interconnecting block mold. In some embodiments, the hollow interconnecting block mold comprise 6061 aluminums. In certain embodiments, the hollow interconnecting block mold comprise 7050 aluminums. In some embodiments, the hollow interconnecting block mold comprise cement. In certain embodiments, the hollow interconnecting block mold comprise hydraulic cement. In further embodiments, the hollow interconnecting block mold comprise cementitious materials. In some embodiments, the hollow interconnecting block mold comprise glass. In other embodiments, the hollow interconnecting block mold comprise plastic. In certain embodiments, the hollow interconnecting block mold comprise high-density polyethylene (HDPE or No. 2 plastic). In still further embodiments, the hollow interconnecting block mold comprise clear plastic. In additional embodiments, the hollow interconnecting block mold comprise silicone. In additional embodiments, the hollow interconnecting block mold comprise polyvinyl chloride. In further embodiments, the hollow interconnecting block mold comprise metal or alloy. In certain embodiments, the hollow interconnecting block mold comprise aluminum, copper, brass, or stainless steel. In additional embodiments, the hollow interconnecting block mold comprise wood and/or wood products. In some embodiments, the hollow interconnecting block mold comprise cloth. In further embodiments, the hollow interconnecting block mold comprise insulation. In some embodiments, the hollow interconnecting block mold comprise rubber. In some embodiments, the hollow interconnecting block mold comprise flexible rubber. In some embodiments, the hollow interconnecting block mold comprise nitrile. In some embodiments, the hollow interconnecting block mold comprise sponge. In some embodiments, the hollow interconnecting block mold comprise a cellular mixture known as bio-ink. In some embodiments, the hollow interconnecting block mold comprise polymeric hydrogels. In some embodiments, the hollow interconnecting block mold comprise ceramic. In some embodiments, walls or floors or other structures constructed with hollow interconnecting block mold comprising the hollow interconnecting block mold are made of a material and filled with another material. The walls or floors or structures comprising the hollow interconnecting block mold may be filled with air, floatable foam, insulation, or a cementitious material, or another material. In further embodiments, the hollow interconnecting block mold comprise a combination of materials described herein.

The faces of the hollow interconnecting block mold can be thick or thin depending on the application of the block mold and the structure being manufactured or built. In some embodiments, the face or faces are thin. In other embodiments, the face or faces are thick. In further embodiments, the face or faces have a thickness ranging from about 1 mil to about 12″. In some embodiments, the faces comprise an inner wall and an outer wall. In some embodiments, the faces comprise an inner wall and an outer wall and are hollow in between the inner wall and outer wall. In further embodiments, the faces are filled with a material between the inner wall and outer wall.

The size and thickness of the outward protrusions can have a variety of sizes. The size of outward protrusions may vary on each face. The size of the connecting outward protrusions may be of a different size of the center outward protrusion on the same face or on different faces. Outward protrusions of one block mold may be connected to another block mold with a coupling, couplings, or a separate pipe or pipes that connects between the two block molds, and or with a piece of threaded rod inside the outward protrusions of two blocks with a washer and a nut wound on each end of the threaded rod within the interior hollow center spaces of the two block molds.

The hollow interconnecting block mold can have a variety of sizes. In some embodiments, the block molds have edges that are uniform length. In other embodiments, the block molds have one length on the edges of the end faces and a different length along the edges of the parallelogram faces that are not part of the end but are the edges between parallelogram faces.

In some embodiments, where measurements do not include the outward protrusions but only the body of the block mold that encapsulates the interior hollow center space, the block molds are 8-inches cubed with 2-inch long outward protrusions, in other embodiments the block molds range in size from about 1 foot to about 20 feet. In other embodiments, the block mold ranges in size from about 1 foot to about 15 feet. In further embodiments, the block mold ranges in size from about 1 foot to about 10 feet. In still further embodiments, the block mold ranges in size from about 1 foot to about 8 feet. In other embodiments, the block mold ranges in size from about 1 foot to about 6 feet. In some embodiments, the block mold ranges in size from about 1 foot to about 4 feet. In some embodiments, the block mold ranges in size from about 1 foot to about 3 feet.

In some embodiments, where measurements do not include the outward protrusions but only the body of the block mold that encapsulates the interior hollow center space, the hollow interconnecting block molds range in size from about 1 inch to about 12 inches. In further embodiments, the hollow interconnecting block mold ranges in size from about 1 inch to about 8 inches. In still further embodiments, the hollow interconnecting block mold ranges in size from about 1 inch to about 3 inches. In particular embodiments, the hollow interconnecting block mold range in size from about 1 inch to about 2 inches. In still particular embodiments, the hollow interconnecting block mold ranges in size from about 250 mils to about 1 inch. In yet still particular embodiments when plasma is being used for medical purposes, the hollow interconnecting block mold ranges in size is measured in microns.

In some embodiments, the edges of the block mold are about 1 foot long. In some embodiments, the edges of the block mold are between about 1 and about 2 feet long, inclusive. In further embodiments, the edges of the block mold are between about 2 and about 3 feet long, inclusive. In still further embodiments, the edges of the block mold are between about 3 and about 4 feet long, inclusive. In yet further embodiments, the edges of the block mold are between about 4 and about 5 feet long, inclusive. In certain embodiments, the edges of the block mold are between about 5 and about 6 feet long, inclusive.

In some embodiments, the edges of the end faces of a block mold range in size from about 1 inch to about 10 feet and the edges of the parallelogram faces of the block mold range in size from about 1 inch to about 10 feet.

In some embodiments, a block mold further comprises a faceplate attached to the connecting outward protrusions of the block mold. A faceplate is designed to protect the inside hollow areas of the block mold and outward protrusions from any material entering into the interior hollow center space of the structure of the hollow interconnecting block mold and its outward protrusions, particularly when the block mold is being prepared to be encapsulated by materials such as liquified self-hardening cementitious materials. A faceplate can also be used to be used as part of a form used to produce the desired shape of structure designed for the hollow interconnecting block mold. A faceplate may be designed to cover the center outward protrusion, vertex connecting outward protrusions, edge connecting outward protrusions, or some combination of center outward protrusion, vertex connecting outward protrusions, edge connecting outward protrusions, as well as creating a boundary for materials designed to encapsulate the hollow interconnecting block mold, such that the materials to encapsulate the hollow interconnecting block mold used to manufacture a hollow interconnecting block, as the mold is contained within the area formed by the faceplates, to retain the material(s), such as liquified self-hardening cementitious materials within the desired contents of the faceplates.

When a faceplate is attached to the connecting outward protrusions on a face, designed to provide a seal for any outward protrusion of the block mold having outward protrusions, fortifying materials do not pass through the outward protrusions on that face, as desired. When a structure is created from interlocked block molds, faceplates can be attached to a plurality of outward protrusions on each of the designed faces of the hollow interconnecting block mold structure prior to filling the space between the hollow interconnecting block molds and the faceplates with a fortifying material to encapsulate all the molds designed to be encapsulated.

In some embodiments, a plurality of faceplates is attached to a block mold or attached to a plurality of block molds. For example, when a wall is created from hollow interconnecting block molds, faceplates can be attached to one or more of the connecting outward protrusions on the faces of the block mold. Then, fortifying material can be poured to encapsulate the structure made with the connecting of the hollow interconnecting block molds, within the confines of the walls made with faceplates, wherein the fortifying material will flow inside of the confines of the hollow interconnecting block mold structure, whereas the hollow areas inside the molds remains hollow, established by the protection of outward protrusion rim membranes and/or the faceplates that were mounted to the outward protrusions on the faces of the block molds, preventing the fortifying material from flowing inside the hollow areas of the mold, whereas the interior hollow center spaces of the molds remain hollow and the block molds exterior walls become encapsulated within the walls comprised of the attached faceplates or other formed structure designed to serve for containing the mold structure.

Faceplates can be made of the same material as the hollow interconnecting block mold or of a different material. In various embodiments, faceplates comprise wood, plastic, HDPE, PVC, rubber, nitrile, glass, metal, metal alloy, aluminum, brass, copper, stainless steel, cloth, cementitious materials, ceramic, gasket material, silicone, or combinations thereof.

In some embodiments, the faceplates are adorned with designs or pictures to create an aesthetically pleasing appearance when attached to interlocked block mold. In certain embodiments, a plurality of faceplates makes up a large design. For example, a large design can be an image of nature, or a city, or a sequence, or an underwater scene, etc. In other embodiments, each faceplate has its own picture, painting, image, or design on it.

### Methods of Connecting Hollow Interconnecting Block Molds

This disclosure also provides methods of connecting hollow interconnecting block molds. The hollow interconnecting block molds of this disclosure are designed to be able to be connected or interconnected to any face of any mold having the same proximate size and configuration of outward protrusions, connected together internally from within the interior hollow center spaces of the aligned molds, whereas when two molds are proximate, wherein the first block mold having the first face having the first outward protrusions is brought in alignment with the second mold having the second face having the second outward protrusions, whereas all of the outward protrusions between the first block mold and the second block mold are in proximate alignment, wherein mechanical hardware can be brought into the interior hollow center spaces of each of the molds via the center outward protrusions of the first and second block molds, whereas from within the interior hollow center spaces of each of the block molds, parts of the mechanical hardware would pass through the connecting outward protrusions of each mold which are proximate at their ends, wherein the hollow spaces of the outward protrusions are aligned as such to allow a piece of threaded rod to pass through the first outward protrusion of the first face of the first mold then continue to pass through the second connecting outward protrusion of the second face of the second mold, wherein all connections are made within the interior hollow center spaces of each of the block molds.

The molds may also be connected together by fusing, gluing, or otherwise attaching the proximate outward protrusions at their ends, with pipes, couplings, unions, or otherwise be welded or connected together.

The block mold can be connected on any of the faces that have outward protrusions to be connected to, whereas the center outward protrusions and connecting outward protrusions and on the first block mold become into alignment with the center outward protrusions and connecting outward protrusions on the second block mold, couplings may be brought into alignment with the outward protrusions, wherein the couplings may join together the outward protrusions of the first block mold to the second block mold.

This disclosure provides methods for connecting hollow interconnecting block molds with hardware. In an embodiment of the method, at least one first connecting outward protrusion of a first face of a first hollow interconnecting block mold is aligned with at least one second connecting outward protrusion of a second face of a second hollow interconnecting block mold. In some embodiments, the first face of the first hollow interconnecting block mold comprises a first center outward protrusion and the second face of the second hollow interconnecting block mold comprises a second center outward protrusion, and during the aligning the first center outward protrusion of the first hollow interconnecting block mold is aligned with the second center outward protrusion of the second hollow interconnecting block mold. At least one first connecting outward protrusion of the first face of the first hollow interconnecting block mold is connected to the least one second connecting outward protrusion of the second face of the second hollow interconnecting block mold with hardware from inside the interior hollow center spaces of each of the block molds. The piece of mechanical hardware, in this example the threaded rod has a designed length to exceed the sum of the lengths of the outward protrusions and account for the total lengths of any additional hardware to connect to each of the ends of the threaded rod, whereas inside the interior hollow center space of the first block mold the threaded rod passes by the interior face of the first block mold, through the wall thickness, then through the exterior face where the connecting outward protrusion is at its base, and through the first connecting outward protrusion and through the first outward protrusion's rim and then passes through the rim of the second connecting outward protrusion of the second block mold and continues passing through the second connecting outward protrusion until it reaches its base, then passes thorough the exterior face, passes through the wall thickness, then passes through the interior face of the second block mold and into the interior hollow center space of the second block mold, wherein each end of the threaded rod protrudes through the interior faces and into the interior hollow center spaces of each of the block molds to allow each of the two ends of the threaded rod to pass through a washer and a nut is wound on to each of the ends of the threaded rod inside each of the block mold's interior hollow center space, connecting the first block mold to the second block mold.

Connecting the blocks together may be accomplished by human hands that bring the mechanical hardware through the center face holes, with one hand in the first interior hollow center space of the first block and the other hand in the interior hollow center space of the second block, whereby the mechanical hardware may be manipulated to connect the two blocks together utilizing the connecting outward protrusions with the mechanical hardware.

This disclosure provides methods for connecting hollow interconnecting block molds with connection couplings or pipes. In an embodiment of the method, at least one first connecting outward protrusion of a first face of a first hollow interconnecting block mold is aligned with at least one second connecting outward protrusion of a second face of a second hollow interconnecting block mold. In some embodiments, the first face of the first hollow interconnecting block mold comprises a first center outward protrusion and the second face of the second hollow interconnecting block mold comprises a second center outward protrusion, and, during the aligning, the first center outward protrusion of the first hollow interconnecting block mold is aligned with the second center outward protrusion of the second hollow interconnecting block mold. At least one first connecting outward protrusion of the first face of the first hollow interconnecting block mold is connected to the least one second connecting outward protrusion of the second face of the second hollow interconnecting block mold with connection couplings or pipes. The connection couplings or pipes are affixed to the exterior of one or more outward protrusions of the first hollow interconnecting block mold and of the second hollow interconnecting block mold, as the block molds are in alignment the couplings or pipes becomes affixed to the exterior of the one or more of the second outward protrusions of the second face of the second block mold. In certain applications the couplings or pipes can be affixed to the inside hollow spaces of the outward protrusions, or using either or, and sometimes multiple methods of using unions, couplings, or pipes on both the interior and exterior of the outward protrusions, wherein mechanical hardware may also be used in addition to the unions, couplings, or pipes, as a method for connecting the molds together.

Any suitable connecting hardware or connecting couplings can be used. The disclosure provides numerous types of hardware that can be used. There are numerous types of connecting couplings and pipes that can be used, such as in various types of materials and design, such as metal pipes, fittings, unions, and couplings, PVC pipes, fittings, unions, and couplings, rubber couplings with band clamps, and other various mechanical exterior couplings. Outward protrusions of the first block mold may also be welded together with the outward protrusion of the second, from the outside or inside of the block mold's interior hollow center space. However, the embodiments provided in the disclosure are not meant to be exhaustive of all possible types of hardware, pipe, fittings, unions, and couplings, or connecting methods that can be used. In some embodiments, the hardware comprises a screw. In some embodiments, the hardware comprises a nail. In some embodiments, the hardware comprises a bolt and a nut. In other embodiments, the hardware comprises threaded rod and a nut. In still other embodiments, the hardware comprises a washer. In further embodiments, the hardware comprises locking inserts which can be inserted into the at least one first connecting outward protrusion of the first face of the first hollow interconnecting block mold and into the least one second connecting outward protrusion of the second face of the second hollow interconnecting block mold, thereby connecting the two hollow interconnecting block molds. In still further embodiments, the hardware comprises mechanical fasteners. In additional embodiments, the hardware comprises grommets, rubber couplings, or O-rings. In other embodiments, the hardware comprises inserts, latches, pins, retaining clips, rivets, rivet nuts, threaded pipes, socket products, springs, toggle bolts, expandable foam inserts, expandable anchors, concrete anchors, plastic hardware, nuts, washers, and bolts. In some embodiments, the hardware is a combination of any of the hardware described herein, or other suitable hardware.

In some embodiments, the method comprises connecting a plurality of the first connecting outward protrusions of the first face of the first hollow interconnecting block mold to a plurality of the second connecting outward protrusions of the second face of the second hollow interconnecting block mold. In certain embodiments, the method comprises connecting all of the first connecting outward protrusions of the first face of the first hollow interconnecting block mold to all of the second connecting outward protrusions of the second face of the second hollow interconnecting block mold. In further embodiments, the method comprises connecting at least one third connecting outward protrusion of a third face of the first hollow interconnecting block mold with at least one fourth connecting outward protrusion of a fourth face of a third hollow interconnecting block mold. In yet another embodiment, center outward protrusions are connected together, before, during, and/or after the connecting outward protrusions have been connected together.

In some embodiments, the method comprises connecting two hollow interconnecting block molds together. In some embodiments, the method comprises connecting more than two hollow interconnecting block molds together. In additional embodiments, the method comprises connecting a plurality of block molds in different directions. In further embodiments, the method comprises connecting more than two hollow interconnecting block molds together to build a structure. In some embodiments, the structure is a wall, a floor, a foundation, or a building. In other embodiments, the structure is a floatable raft. In further embodiments, the structure is a garden. In still further embodiments, the structure is home for aquatic life or an artificial reef.

In some embodiments, additional materials are used when connecting the hollow interconnecting block mold. In some embodiments, gaskets are placed between the outward protrusions of the connected hollow interconnecting block molds. In some embodiments, fusible links and/or sealants are placed between outward protrusions of the connected hollow interconnecting block molds to strengthen the bond between the block molds.

In some embodiments, the hollow interconnecting block molds are aligned and fused together by causing plastic coatings on each outward protrusion of block mold to melt and fuse together. In other embodiments, the hollow interconnecting block mold can be aligned and glued together. In still other embodiments, the hollow interconnecting block mold can be welded or brazed together. In some embodiments, the hollow interconnecting block molds are connected together without hardware, but with connector couplings connecting the outward protrusions of the hollow interconnecting block molds. A person of ordinary skill in the art can envision additional ways to connect the hollow interconnecting block mold of this disclosure. Such connection methods are envisioned within the scope of this disclosure.

In some embodiments, the method further comprises connecting one or more faceplates to one or more outward protrusions of the one or more faces of a hollow interconnecting block mold or to one or more faces of one or more interlocked block molds. In such methods, the holes of a faceplate are aligned with the connecting outward protrusions of a face of a hollow interconnecting block mold. Then, the faceplate seals the face center outward protrusion, whereas the faceplate is attached to the connecting outward protrusions of that face, as the holes of the faceplate align with rims of the connecting outward protrusions, wherein connection of the faceplate to the outward protrusions of the mold is accomplished by using mechanical hardware from within the interior hollow center space of the mold, whereas threaded rod is allowed to pass through the connecting outward protrusions and through the holes of the faceplate and connected together with washers and nuts on each end of the threaded rod. In an additional method to affix a faceplate to the outward protrusions of the face of the mold, the inside face of the faceplate has outward protrusions that may connect to the outward protrusions on the block mold, whereas the faceplate that will become flush with the rims of the outward protrusions has outward protrusions of a designed length, and designed inside or outside diameter designed to accommodate the ability for the faceplate to become attached, whereas they may be glued, pressed, using couplings or otherwise connected by a mechanical means.

In further embodiments, the method comprises filling the interior of the structure comprising hollow interconnecting block molds with a fortifying material. In some embodiments, the fortifying material is insulation, foam, sand, water, gravel, rocks, cementitious material, metal reinforcements, or a combination thereof. In some embodiments, the fortifying material is poured, pumped, or otherwise added to flow through the exterior structure of the interlocked block molds.

In still further embodiments, the method comprises encapsulating the block mold to preserve its interior hollow center space, and to protect the entire hollow structure comprising hollow interconnecting block molds by encapsulating the entire structure with a fortifying material. In some embodiments, metal rebar, wire mesh, and other reinforcing materials are attached to the exterior walls of the outward protrusions of the structure created by the block molds, whereas the hollow interconnecting block molds become encapsulated by fortifying materials, such as insulation, foam, sand, water, gravel, rocks, cementitious material, metal reinforcements, or a combination thereof. In some embodiments, the fortifying material is poured, pumped, or otherwise added to flow through the exterior structure of the interlocked block molds.

### Manufacturing Hollow Interconnecting Block Molds

The hollow interconnecting block mold can be made through a variety of methods depending on the materials used to make the block mold. Each hollow interconnecting block mold comprises at least three parallelogram faces, a top end base face, and bottom end base face, wherein each face is comprised of a wall thickness of one or more materials, with each face. In some embodiments, the hollow interconnecting block molds are cast poured. In other embodiments, the hollow interconnecting block molds are made from one uniform piece. In some embodiments, the hollow interconnecting block molds are made by sewing faces together, gluing faces together, clamping, welding, and/or otherwise connecting the block molds edges together so that the vertex of each of the face aligns together with the vertex of an adjacent face and attaching outward protrusions. In other embodiments, hollow interconnecting block molds are manufactured in one single pour. In other embodiments, hollow interconnecting block molds are manufactured from one-piece faces, wherein faces are not manufactured by assembling materials together, whereby the block mold is manufactured by connecting the faces together to manufacture a block mold. In other embodiments, hollow interconnecting block molds are manufactured by drilling holes in a hollow box and attaching center and connecting outward protrusions to the exterior faces of the hollow box.

In some embodiments, particularly where the hollow interconnecting block mold comprise plastic, hollow interconnecting block molds are manufactured by roto-molding, rotational molding, injection molding, plastic extrusion molding, blow molding, vacuum molding, or by other suitable molding methods. In further embodiments, the hollow interconnecting block molds are constructed from two or more separately constructed components and then joined together. In some embodiments, particularly when the hollow interconnecting block mold comprise metal, the hollow interconnecting block mold are made by bolting the faces together, or welding faces together, or brazing faces together, or machining, casting, forming, joining, or assembling. In additional embodiments, particularly when the hollow interconnecting block mold comprise wood, the hollow interconnecting block mold are made by being machined, assembled, glued together, screwed, nailed, casted, or formed as an engineered wood product. In further embodiments, the hollow interconnecting block molds are produced by 3D printing or additive manufacturing, or any process in which material or materials are joined or solidified under computer control to create a three-dimensional object. In some embodiments, rapid prototyping is used to produce the hollow interconnecting block mold. In further embodiments the manufacturing of a hollow interconnecting block mold is accomplished by using a combination of the various methods.

One method of using a hollow interconnecting block mold comprised of flexible rubber-like materials to manufacturing a hollow interconnecting block comprised of six faces, wherein sand or other easily removable materials is used to fill the inside the interior hollow center space and all of the hollow portions of the flexible rubber-like block mold, including filling the hollow portions of the outward protrusions of the mold, whereby the block mold is placed inside a container, with the top side of the container open to the free air, whereas the rims of the outward protrusions are sealed with membranes and the rims of the outward protrusions have been secured at their desired locations, wherein deleterious materials are prevented from entering the mold, wherein liquified self-hardening cementitious materials is poured into the container from the open top side, encapsulating the block mold, whereas after the block has cured, the sand and/or removable materials are emptied from the flexible rubber-like mold and the mold is extracted from the cured block, whereby the hollow interconnecting block has been manufactured.

In some embodiments, the block molds are made as solid pieces and then desired center outward protrusions, connecting outward protrusions, or edge outward protrusions are drilled and milled, and the interior space is hollowed out for mechanical hardware to be used to pass through the connecting outward protrusions. For example, in some embodiments, a solid prism is manufactured and then each face is drilled and milled with the desired configuration of outward protrusion locations and then a drill cutting wheel enters into the face center outward protrusion locations and hollows out the interior portion of the block mold.

To better understand the ability to manipulate the block molds, for assembly purposes, I wish to disclose that in nearly all embodiments, the interior hollow center spaces of the hollow interconnecting block molds are accessible, either by human hands, specialized tools, or by other means, whereas to be able to bring materials, tools, mechanical hardware, parts, and pieces, by accessing the interior hollow center space through the center outward protrusions, wherein the typical 8-inch cuboid interior hollow center space is accessed through 4½-inch in diameter center outward protrusions, whereas the typical 8-inch cuboid block mold has center outward protrusions a proximate 2-inches long and connecting outward protrusions a proximate ¾″-inches in diameter a proximate 2-inches long, whereas typically all exterior faces have center outward protrusions for access into the interior hollow center space, whereas these block molds were designed for easy accessibility and manufacturing hollow interconnecting blocks, because of the need to build structures to protect humanity from the climate crisis becomes more evident every day, as I believe that these block molds can manufacture the best and most versatile blocks and structures to help protect humanity and help make further improvements to infrastructures into the future.

### Examples

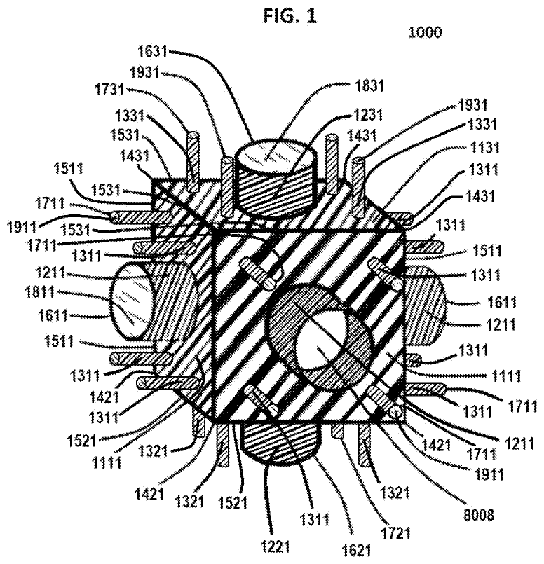

One embodiment of a hollow interconnecting block mold 1000 is shown in FIG. 1, block mold 1000 comprises six exterior faces, twelve edges, eight vertices, one hollow center outward protrusions proximate the center on each exterior face, four hollow connecting outward protrusions proximate each vertex on each exterior face, an interior hollow center space, and six interior faces that encapsulate the interior hollow center space, as the interior hollow center space is located between the walls of the interior faces inside the hollow interconnecting block mold. The body of the block mold has a wall thickness between the interior face and exterior face. Outward protrusions may have a different wall thickness than from the body of the block mold. Exterior faces may or may not comprise outward protrusions, whereas interior faces do not have outward protrusions, whereas interior faces may have holes whereby the outward protrusion begins on the other side of the wall thickness where the outward protrusion begins from the exterior face, whereas traveling from the rim at the top of the outward protrusion to inside the body of the block mold, there would be traveling through the outward protrusion, then traveling through the wall thickness, continuing to travel and passing by the interior face to enter the interior hollow center space of the block mold, as is a portion of the path of travel for the threaded rod as it is designed to secure two block molds together. Although block mold 1000 has eight vertices at the point where three ends meet at the eight corners on block 1000, block mold 1000 is comprised of six individual faces with each individual face comprising four vertices, whereas assembling the six faces together to manufacture block mold 1000, three vertices from three faces joined together comprise three edges that meet at the one vertex, as true for each of the eight vertices of block mold 1000. Block mold 1000 comprises eight three-dimensional vertices at the eight points where three edges meet, as each individual face comprise a vertex at the point where two ends meet.

Block mold 1000 of FIG. 1 is comprised of four parallelogram exterior faces 1111 (not all shown in FIG. 1), one bottom end base exterior face 1121 (not shown in FIG. 1), and one top end base exterior face 1131, wherein each of the four parallelogram exterior faces 1111 comprises one parallelogram face center outward protrusion 1211 and four parallelogram exterior face connecting outward protrusions 1311, wherein the one bottom end base exterior face 1121 comprises one bottom end base exterior face center outward protrusion 1221 and four bottom end base exterior face connecting outward protrusions 1321, and wherein the top end base exterior face 1131 comprises one top end face center outward protrusion 1231 and four top end face connecting outward protrusions 1331.

The line segment where two parallelogram faces 1111 meet is known as the parallelogram face edge 1511. The line segment where one bottom end base face 1121 meets with one parallelogram face 1111 is known as the bottom end base face edge 1521. The line segment where one top end base face 1131 meets with a parallelogram face 1111 is known as the top end base face edge 1531. The point where two bottom end base face edges 1521 and one parallelogram face edge 1511 meet is known as the three-dimensional bottom end base vertex 1421. The point where two top end base face edges 1531 and one parallelogram edge 1511 meet is known as the three-dimensional top end vertex 1431.

Block mold 1000 of FIG. 1 comprises four parallelogram exterior faces 1111, wherein each parallelogram exterior face 1111 comprises one parallelogram exterior face center outward protrusion 1211, wherein at the end each parallelogram exterior face center outward protrusion 1211 comprises a parallelogram exterior face center outward protrusion rim 1611, wherein each parallelogram exterior face center outward protrusion rim 1611 may comprise a parallelogram exterior face center outward protrusion rim membrane 1811 to protect the interior hollow center space 8008 from deleterious materials entering into the block mold.

Block mold 1000 of FIG. 1 comprises four parallelogram exterior faces 1111, wherein each parallelogram exterior face 1111 comprises four parallelogram exterior face connecting outward protrusion 1311, wherein at the end of each parallelogram exterior face center outward protrusion 1311 comprises a parallelogram exterior face connecting outward protrusion rim 1711, wherein each parallelogram exterior face connecting outward protrusion rim 1711 may comprise a parallelogram exterior face connecting outward protrusion rim membrane 1911 to protect the interior hollow center space 8008 from deleterious materials entering into the block mold.

Each of the four parallelogram exterior faces 1111 comprises four parallelogram exterior face connecting outward protrusions 1311, wherein each parallelogram exterior face connecting outward protrusions 1311 comprises a parallelogram exterior face connecting outward protrusion rim 1711, wherein a parallelogram exterior face connecting outward protrusion rim membrane 1911 may be affixed to each parallelogram exterior face connecting outward protrusion rim 1711 to protect from deleterious materials from entering into the interior hollow center space 8008.

Block mold 1000 of FIG. 1 comprises one bottom end base exterior face 1121, wherein each bottom end base exterior faces 1121 comprises one bottom end base exterior face center outward protrusion 1221, wherein each bottom end base exterior face center outward protrusion 1221 comprises a bottom end base exterior face center outward protrusion rim 1621, wherein the bottom end base exterior face center outward protrusion 1221 may comprise a bottom end base center outward protrusion rim membrane 1821 to protect from deleterious materials from entering into the interior hollow center space 8008.

The one bottom end base exterior face 1121 comprises four bottom end base exterior connecting outward protrusions 1321, wherein each bottom end base exterior face connecting outward protrusions 1321 comprises a bottom end base exterior face connecting outward protrusion rim 1721, wherein a bottom end base exterior face connecting outward protrusion rim membrane 1921 may be affixed to each bottom end base exterior face connecting outward protrusion rim 1721 to protect from deleterious materials from entering into the interior hollow center space 8008.

Block mold 1000 of FIG. 1 comprises one top end base exterior face 1131, wherein each top end base exterior faces 1131 comprises one top end base exterior face center outward protrusion 1231, wherein each top end base exterior face center outward protrusion 1231 comprises a top end base exterior face center outward protrusion rim 1631, wherein the top end base exterior face center outward protrusion 1231 may comprise a top end base exterior face center outward protrusion rim membrane 1831 to protect from deleterious materials from entering into the interior hollow center space 8008.

The one top end base exterior face 1131 comprises four top end base exterior connecting outward protrusions 1331, wherein each top end base exterior face connecting outward protrusions 1331 comprises a top end base exterior face connecting outward protrusion rim 1731, wherein a top end base exterior face connecting outward protrusion rim membrane 1931 may be affixed to each top end base exterior face connecting outward protrusion rim 1731 to protect from deleterious materials from entering into the interior hollow center space 8008.

The six walls of block mold 1000 of FIG. 1 is comprised of a uniform wall thickness between the interior faces and the exterior faces of the body of block mold 1000, wherein the block molds exterior walls comprises four parallelogram exterior faces 1111, one bottom end base exterior face 1121, and one top end base exterior face 1131, wherein the block molds interior walls comprises four parallelogram interior faces 8111, one bottom end base interior face 8121, one top end base interior face 8131, wherein the interior hollow center space 8008 is contained within the interior faces of the six walls of the block mold 1000.

Outward protrusions may not have the same wall thickness as the walls of the block mold but outward protrusions are hollow like the block mold is hollow, wherein materials may enter through the outward protrusions to proceed into the interior hollow center volume space 8008 from outside of the block mold or may pass from the inside the interior hollow center volume space 8008 through the outward protrusions into an outward protrusion of another block mold 1000 or may be designed to exit outside of the block mold 1000 to the free atmosphere.

Two parallelogram exterior faces 1111 are shown in FIG. 1. Each parallelogram exterior face 1111 comprises a center outward protrusion 1211 around the center of face 1111. The top end base face 1131 comprises a center outward protrusion 1231 around the center of top end base face 1131. The bottom end base face 1121 (not shown in FIG. 1) comprises a center outward protrusion 1221 around the center of face 1121. Although the center outward protrusions shown in FIG. 1 have a circular shape, the center outward protrusions need not be circular. Each parallelogram face 1111 shares vertices 1431 with the top end base face 1131 of the block mold 1000, just as each parallel face 1111 shares vertices 1421 with the bottom end base face 1121 of each block mold 1000. Connecting outward protrusions 1311 are proximate to vertices 1421 and 1431 of each parallelogram exterior face 1111. Connecting outward protrusions 1331 on the top end base face 1131 of the block mold are proximate to vertices 1431. The bottom end base face 1121 (not shown in FIG. 1) comprise connecting outward protrusions 1321 proximate to vertices 1421. Although each of the connecting outward protrusions 1321 and 1331 are shown to have a circular shape in FIG. 1, connecting outward protrusions need not be circular.

Parallelogram exterior faces 1111 of block mold 1000 all have the same proximate configuration, size, shape, and dimensions, in FIG. 1, including the faces not shown in FIG. 1. The top end face 1131 and the bottom end base exterior face 1121 both have the same proximate configuration, size, shape, and dimensions, in block mold 1000 in FIG. 1. Block mold 1000 of FIG. 1 is comprised of six walls wherein all six exterior faces comprise the same proximate dimensions with the same proximate configuration of outward protrusions, whereas the four parallelogram exterior faces 1111, the one top end exterior face 1131, and the one bottom end base exterior face 1121 all have the same proximate configuration, wherein block mold 1000 could be also known as a cuboid having the same proximate configuration on all sides, enabled to be connected to any other block mold 1000 from either side to either side, as the face center outward protrusions have the same proximate size, shape, and configuration and the face connecting outward protrusions on each side all have the same proximate size, shape, and configuration.

The interior hollow center space 8008 comprise the interior hollow portion of the block mold 1000, wherein the interior hollow center space 8008 is the space between all of the interior faces of the block mold, wherein there are four parallelogram interior faces 8111, one top end interior face 8131, and one bottom end interior face 8121, whereas all six interior faces encapsulate the interior hollow center space 8008, whereas a hollow interconnecting block mold 1000 having the exterior face dimensions of a cube with each edge having a proximate 8 inches in length, 8 inches in width, and 8 inches in height, with a uniform total length from end to end from all rims of all outward protrusions to all rims of all outward protrusions on the same plane have a length of a proximate twelve inches, whereas each outward protrusion is a proximate 2 inches in length, one must account for the wall thicknesses of the body of the block mold and the thicknesses of the outward protrusions to formulate accurate volume calculations, whereas if block mold 1000 were to placed in a container to be encapsulated to manufacture a hollow interconnected block.

The interior hollow center space 8008 would be a proximate 8 inches cubed, whereas the volume of interior hollow center space 8008 of block mold 1000 would total a proximate 512 cubic inches. The interior 8008 volume and length of outward protrusions is contingent on the wall thickness of the mold, whereas the dimensions of the interior faces would differ from the dimensions of the exterior faces in relation to the wall thickness of the block mold. Not all interior or exterior faces are shown in FIG. 1.

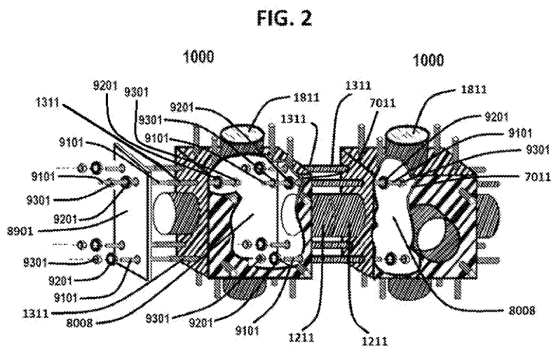

Referring now to FIG. 2, two block molds 1000, from the block mold depicted in FIG. 1, are being physically connected together with mechanical hardware from inside the interior hollow center spaces 8008 of each of the tow block molds 1000, with threaded rod 9101, washers 9201, and nuts 9301, as the threaded rod 9101 passes through the first hole of parallelogram interior face 8111, through the wall thickness 7011, through the parallelogram exterior face 1111 and entered into the first parallelogram face connecting outward protrusion 1311 and then passes through the parallelogram face connecting outward protrusion rim 1711, then continuing its forward movement into the second block mold 1000 by passing through second parallelogram face connecting outward protrusion rim 1711 of the second block mold 1000, then passes through the parallelogram exterior face 1111 and then through the wall thickness 7011 of the second block mold 1000, then passes through the parallelogram interior face 8111 and into the interior hollow center space 8008 of the second block mold 1000, whereas the first end of the threaded rod is protruding into the interior hollow center space of the first block mold 1000 and the second end of the same threaded rod is protruding into the interior hollow center space of the second block mold, wherein each end of the threaded rod 9101 passes through a washer 9201 and a nut 9301 is wound on to both of the ends of the threaded rod 9101, whereas the nuts are tightened, whereby washers 9201 are pressed flush against the parallelogram interior face 8111, as the nuts 9301 are wound on and fit tightly to connect the two block molds 1000 together.

In FIG. 2 faceplate 8901 is being connected to the parallelogram face connecting outward protrusions of block mold 1000, whereas the faceplate 7011 will become physically attached to the parallelogram connecting outward protrusions 1311 with mechanical hardware from inside the interior hollow center space 8008 to the exterior side of the faceplate 7011, with threaded rod 9101, washers 9201, and nuts 9301, as from within the interior hollow center space 8008 the threaded rod 9101 passes through the first hole in the parallelogram interior face 8111, through the wall thickness 7011, through the parallelogram exterior face 1111 and entered into the first parallelogram face connecting outward protrusion 1311 and passed the parallelogram face connecting outward protrusion rim 1711, then passes through the first hole of the faceplate 7011, and continuing the threaded rod passes through a washer 9201 and a nut 9301 is wound on to the end of the threaded rod 9101 to secure the faceplate 7011, wherein the other end of the threaded rod 9101 remains in the interior hollow center space 8008, wherein the threaded rod 9101 passes through a washer 9201 and a nut 9301 is wound onto the threaded rod 9101, whereas the nuts 9301 are tightened and the faceplate 7011 has been physically attached to the block mold 1000, wherein the ends of the threaded rod 9101 protrude into the interior hollow center space 8008, the washers 9201 are pressed flush against the parallelogram interior face 8111, as the nuts 9301 are wound on and fit tightly.

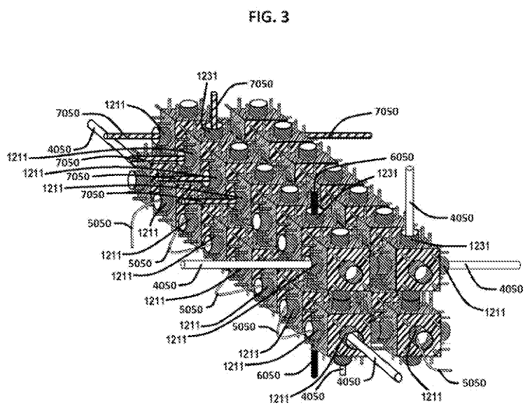

Referring now to FIG. 3, a plurality of thirty hollow interconnecting block molds 1000 have been aligned and connected together with mechanical hardware through the connecting outward protrusions proximate the vertices. Twenty-four hollow interconnecting block molds are visible. Hollow interconnecting block molds 1000 can be connected to all six faces of another block mold 1000, as the parallelogram exterior faces 1111, the top end exterior faces 1131, and the bottom end base exterior faces 1121 of block mold 1000 comprise the same dimensions of all their features, which includes all of the six interior faces, all of the six exterior faces of each block molds, wherein each block mold comprise four parallelogram exterior faces 1111, one top end base face 1121, and one bottom end base face 1131, whereas each of the exterior faces comprise one face center outward protrusions, and four connecting outward protrusions, whereas each of the one exterior face outward protrusions on each exterior face are proximate the center of each of the six faces on each of the 30 block molds, and whereas each of the four exterior face connecting outward protrusions on each of the six faces on each of the 30 block molds are proximate the vertices of each of the six faces of each of the 30 block molds, whereas the dimensions and placement of all of the outward protrusions on each face are proximate in being identical to each other.

Referring to FIG. 3, during and/or after the plurality of block mold 1000 block molds are connected together, materials, such as plastic PVC pipes 4050, electrical wires 5050, metal conduit pipes 6050, and metal rebars 7050, can also be passed through all of the desired connected parallelogram face center outward protrusions 1211, the top end base center outward protrusions 1231, and the bottom end base exterior face center outward protrusions 1221 (not shown in FIG. 3). Desired materials can pass through every face center outward protrusion and through every interior hollow center space 8008.

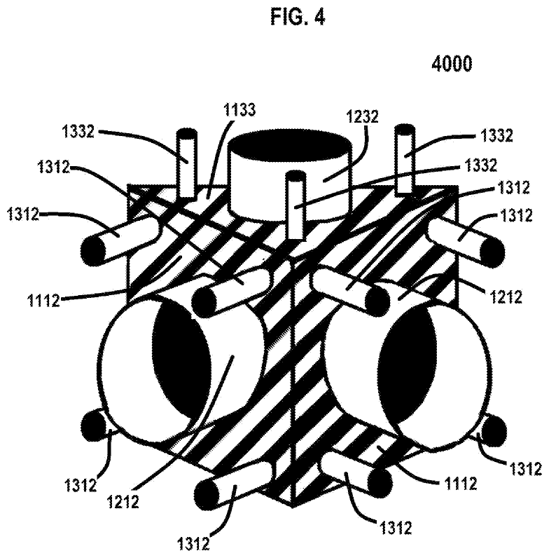

Referring now to FIG. 4, hollow interconnecting block mold 4000 depicts a three-dimensional view of an embodiment of one plastic hollow interconnecting block mold having five faces (two of the sides of the block mold are not shown), whereas each of the two parallelogram faces 1112 comprise one parallelogram face center outward protrusion 1212 and four parallelogram face connecting outward protrusions 1312, wherein the top end base triangular face 1133 comprise one top end triangular face center outward protrusion 1232 and three top end triangular face connecting protrusions 1332, whereas the bottom end base triangular face and the third parallelogram exterior face are not shown in FIG. 4.

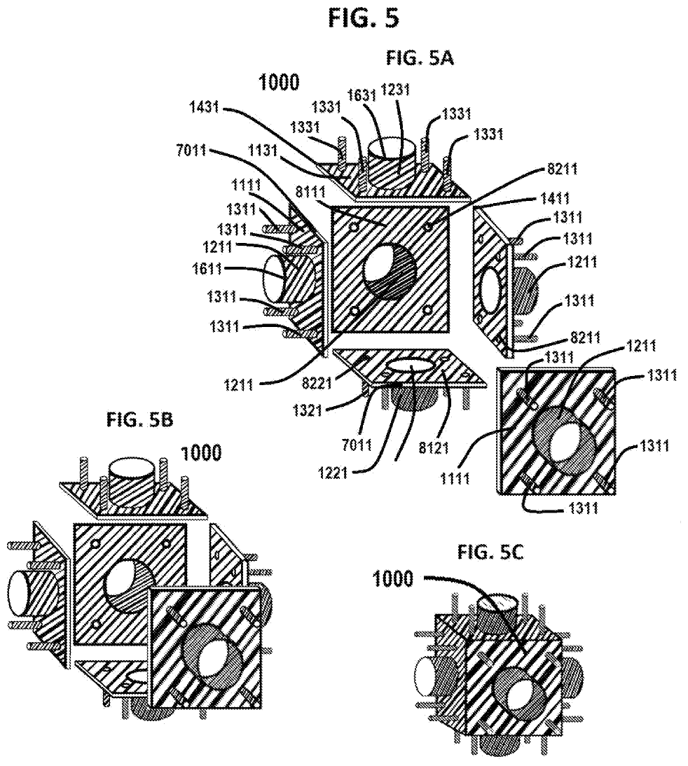

FIG. 5A depicts the six sides of a hollow interconnecting block mold 1000 in six separate pieces comprising a uniform wall thickness, wherein each of the four parallelogram sides comprises one parallelogram exterior face 1111, one parallelogram interior face 8111, a wall thickness 7011, four vertices 1411, one parallelogram face center outward protrusion 1211, and four parallelogram face connecting outward protrusions 1311, one parallelogram interior face 8121, and one parallelogram center face displays center outward protrusion rim 1611, whereas the one bottom end base comprises one parallelogram exterior face 1121 (not shown), a wall thickness 7011, four vertices 1412, one parallelogram face center outward protrusion 1221, and four parallelogram face connecting outward protrusions 1321, and whereas the one top end base side comprises one parallelogram exterior face 1131, one parallelogram interior face 8131 (not shown), a wall thickness 7011, four vertices 1413, one parallelogram face center outward protrusion 1231, and four parallelogram face connecting outward protrusions 1331. Although not all items are shown in FIG. 5A, FIG. 1 hollow interconnecting block mold 1000 may be referenced, because FIG. 5A represents a view of block mold 1000 as the six individual pieces that will be shown as connected together in FIG. 5C, a method to manufacture block mold 1000.

FIG. 5B illustrates the six separate pieces of the hollow interconnecting block mold 1000 moving closer to each other to become proximate and become affixed together at each of the vertices and edges.

FIG. 5C illustrates the product of a manufactured hollow interconnecting block mold 1000, whereas six separate pieces of the hollow interconnecting block mold 1000 moved proximate together, whereas sides of faces formed edges and each vertex of each face combined with two additional vertices from two additional faces and formed a vertex at each corner of the block mold, whereas this block mold comprises 12 edges and 8 vertices, whereas all exterior faces comprise outward protrusions as depicted in FIG. 1 hollow interconnecting block mold 1000.

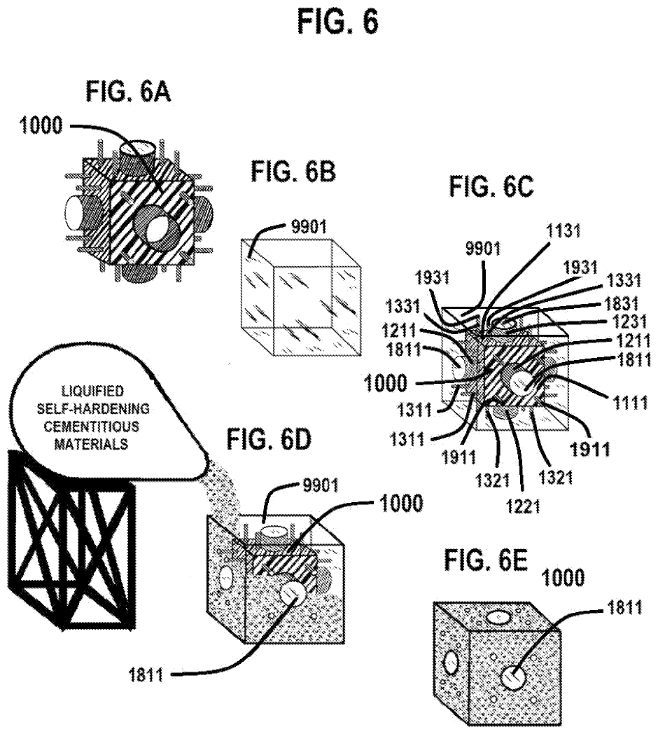

Referring now to FIG. 6A which depicts one hollow interconnecting block mold 1000, displayed in FIG. 1, prepared to be used for manufacturing one hollow interconnecting block, whereas on each of the four parallelogram exterior faces 1111 comprises one parallelogram face center outward protrusion 1211 and four parallelogram face connecting outward protrusions 1311, whereas on the one bottom end base face 1121 comprises one bottom end base face center outward protrusion 1221 and four bottom end base face connecting outward protrusions 1321, whereas on the one top end base face 1131 comprises one top end base face center outward protrusion 1231 and four top end base face connecting outward protrusions 1331.

In FIG. 6A rim membranes have been secured to the rims of all of the outward protrusions of block mold 1000, whereas each of the four parallelogram faces 1111 comprises one parallelogram face center outward protrusion rim membrane 1811 having been secured to each parallelogram face center outward protrusion rim 1611 and one parallelogram face connecting outward protrusion rim membrane 1911 having been secured to each of the four parallelogram face connecting outward protrusion rims 1711, whereas one bottom end base face center outward protrusion rim membrane 1821 having been secured to the one bottom end base face center outward protrusion rim 1621 and one bottom end base face connecting outward protrusion rim membrane 1921 having been secured to each of the four bottom end base face connecting outward protrusion rims 1721, and whereas one top end base face center outward protrusion rim membrane 1831 having been secured to the one top end base face center outward protrusion rim 1631 and one top end base face connecting outward protrusion rim membrane 1931 having been secured to each of the four top end base face connecting outward protrusion rims 1731, wherein the interior hollow center space 8008 of the hollow interconnecting block mold 1000 will become the interior hollow center space for the hollow interconnecting block after the manufacturing process has been completed.

FIG. 6B depicts a transparent container 9901 of six sides, with the top side open to the free air to allow the placement of block mold 1000 to fit snuggly and firmly secured, as the rims of the outward protrusions would become adjacent to the interior walls of the transparent container 9901, whereas the block mold 1000 would become secured into the container to avoid movement and not become out of alignment during the manufacturing process, wherein rebar, wire mesh, or other materials may be affixed to the outward protrusions to increase structural integrity and installed before the block mold 1000 is secured inside of the transparent container 9901, wherein the rims of the outward protrusions have been sealed with membranes.

FIG. 6C depicts the block mold 1000 secured into the transparent container 9901 and prepared to be encapsulated by liquified self-hardening cementitious materials or other desired materials, wherein block mold 1000 has been secured into the transparent container 9901, whereas not all faces, center outward protrusions, nor all connecting outward protrusions are visible in FIG. 6C, rim membranes have been securely installed on all of the rims of all of the outward protrusions.

FIG. 6C depicts rim membranes securely installed to the rims of the outward protrusions, top end base face center outward protrusion rim membrane 1831 on top end base face center outward protrusion 1231, whereas two of the shown parallelogram face center outward protrusions 1211 having parallelogram face center outward protrusion rim membranes 1811, whereas top end base face connecting outward protrusion rim membranes 1931 shown connected to the top end base face connecting outward protrusions 1331, whereas parallelogram face connecting outward protrusion rim membranes 1911 shown connected to parallelogram face connecting outward protrusions 1311, wherein the bottom end base face center outward protrusion 1221, the four bottom end base face connecting outward protrusions 1321, and all of the additional center and connecting outward protrusions that are not shown in FIG. 6C duly have rim membranes installed on all of the outward protrusions in FIG. 6C, wherein all outward protrusions of block mold 1000 have rim membranes duly and securely installed to the rims of the outward protrusions before being capsulated in liquified self-hardening cementitious materials.

FIG. 6D depicts the block mold 1000 becoming encapsulated by liquified cementitious materials, wherein the transparent container 9901 will become filled to flood level rim, wherein the curing process will begin, whereas a protective cover may be installed on top of the transparent container 9901 after the desired materials have been administered into the transparent container 9901, wherein the shown parallelogram face center outward protrusion rim membrane 1811 is an exemplary example of a protection method for preserving the interior hollow center space 8008 of block mold 1000.

FIG. 6E depicts a manufactured hollow interconnecting block with the interior hollow center space and hollow outward protrusions protected by the rim membranes 1811, whereas the block mold 1000 was encapsulated by the liquified self-hardening cementitious materials.

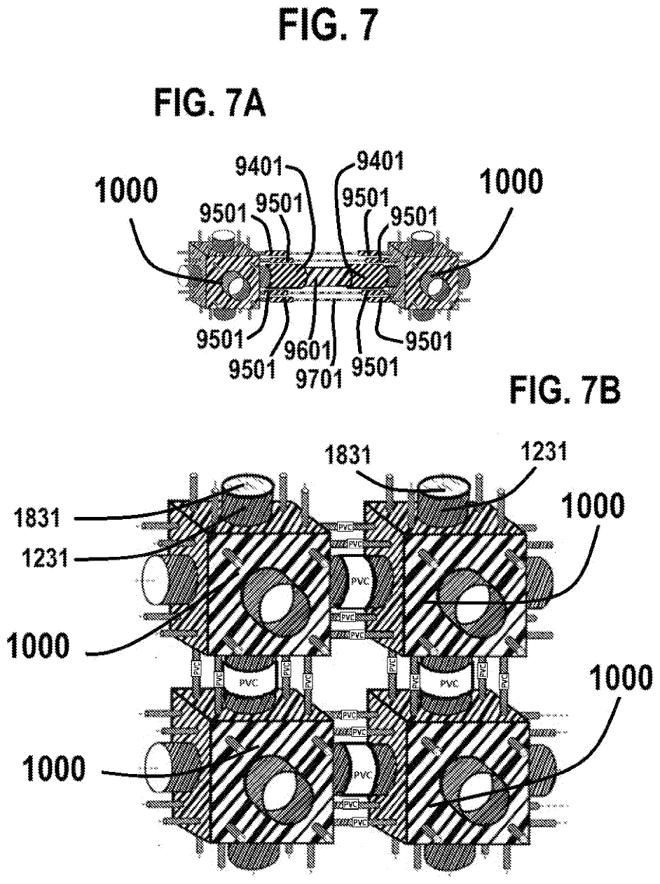

FIG. 7A depicts two hollow interconnected block molds 1000 connected together with couplings and pipes, whereas the parallelogram face center outward protrusions are connected together by one parallelogram face center outward protrusion pipe 9601 connected on each of its ends by parallelogram face center outward protrusion couplings 9401 and to the parallelogram face center outward protrusions, and whereas the parallelogram face connecting outward protrusions are each connected together by one parallelogram face connecting outward protrusion pipe 9701 connected on each of its ends by parallelogram face connecting outward protrusion couplings 9501 and to the parallelogram face connecting outward protrusions, whereby connecting the two block molds 1000 together.

FIG. 7B depicts four hollow interconnecting block molds 1000, illustrated in FIG. 1, connected together using PVC couplings, wherein center face outward protrusions and connecting face outward protrusions have been affixed with a PVC couplings that were glued to the exterior wall of the outward protrusions, whereas the rims of the outward protrusions have been protected from undesirable materials from entering into the outward protrusions and into the interior hollow center space 8008, wherein mechanical hardware may also be utilized to help ensure a secure connection, whereas two of the center top end face outward protrusion rims 1231 are shown to be affixed with rim membranes 1831.

### Retaining Wall and Seawall

In some embodiments, the interconnecting block molds of this disclosure are designed to form a seawall or retaining wall. The outward protrusions of each hollow interconnecting block mold when connected together with other hollow interconnecting block molds of the same configuration create spaces between the faces of the hollow interconnecting block mold for earth, indigenous vegetation, and/or faceplates, to strengthen the shorelines from erosion. Mechanical and electrical utility pipes and wires can pass through the center outward protrusions of all the connected block molds. In such embodiments, a plurality of interconnecting block molds is interlocked together to form the desired wall of any desired configuration. In certain embodiments, the wall can be made vertical. In other embodiments, the wall is a gravity wall, piling wall, cantilever wall, or an anchored wall. In other embodiments, the hollow interconnecting block mold are arranged to create walls with angles or vertices or curved. In still other embodiments, a wall comprising hollow interconnecting block mold is built at an incline. In some embodiments, the tops and bottoms of the hollow interconnecting block molds comprise protrusions and corresponding indentations to receive the protrusions to allow the block mold to connect at an offset to create an incline. In other embodiments, the shape of the hollow interconnecting block mold enables an incline to be created.

Then, faceplates are attached to the outward protrusions of each block mold on either face of the wall. The faceplates are secured in place so that the designed interiors of the block mold and/or the interiors between the faceplates and the exterior of the hollow interconnecting block mold can made void of materials or be filled with a desired material. In some embodiments, interiors of the block mold and/or the interiors between the faceplates and the exterior of the hollow interconnecting block mold wall is filled with sand. In some embodiments, interiors of the block mold and/or the interiors between the faceplates and the exterior of the hollow interconnecting block mold wall is filled with cement. In other embodiments, the interiors of the block mold and/or the interiors between the faceplates and the exterior of the hollow interconnecting block mold wall is filled with rocks or gravel. In further embodiments, the interiors of the block mold and/or the interiors between the faceplates and the exterior of the hollow interconnecting block mold wall is filled with a material of sufficient mass or strength to retain whatever the retaining wall is designed to retain.

Sea walls made from hollow interconnecting block molds promote vegetation and earth to collect within the connected outward protrusions of each block mold, as they are connected together with other block molds. Two, sandbags made from hollow interconnecting block molds with face plates are stronger than typical sandbags due to the block mold being mechanically connected. Three, the sea wall made of hollow interconnecting block molds with face plates attached to the block mold can be filled with a fortifying material such as cement or sand, thereby increasing the strength of the sea wall. Furthermore, in some embodiments, the hollow interconnecting block molds are made of cloth material with plastic face plates. Such hollow interconnecting block mold can be interlocked and filled with sand between the exterior of the block mold and the interior of the attached faceplates to provide a superior sandbag-like structure with mechanically connected block molds.

Hollow interconnecting block molds intended to be used to create a sea wall can be made of noncorroding materials in order to withstand the corrosive nature of the sea.

### Foundation and Structures

In other embodiments, the hollow interconnecting block molds of this disclosure are designed to form a foundation for a building or other structure. In such embodiments, a plurality of hollow interconnecting block molds is connected in horizontal and vertical fashion according to a design for a foundation. The foundation can have any suitable shape depending on the structure being built. In some embodiments, the connected hollow interconnecting block mold form the foundation with material poured into the structure around the exterior portions of the block mold. In other embodiments, once the requisite number of hollow interconnecting block mold are connected, faceplates can be added to the interior face and exterior face of the wall created by the interlocked block mold. Then, a fortifying material can be poured into the interlocked block mold structure, thereby creating a foundation. Additional structures can be built on top of the foundation. In yet further embodiments, faceplates are connected to specific faces of specific molds, to allow hollow areas and solid areas, whereas after liquified self-hardening cementitious materials are poured into the mold structure at designed locations, hollow areas may be used for designed purposes, such as a swimming pool or vault, or any other particular designed use.

In other embodiments, the hollow interconnecting block mold of this disclosure is designed to build a structure. The structure could be a residential building, a commercial building, an office building, sports arena, or any building. In some embodiments, the building is a small building such as a garage or shed. In other embodiments, the building is a residential building such as a house. In further embodiments, the building is a large building. The size of the hollow interconnecting block mold used in buildings can vary depending on the size of the building being constructed.

### Flotation

In another embodiment, the hollow interconnecting block molds with outward protrusions of this disclosure are comprised of a buoyant material. In such embodiments, a plurality of interconnecting molds can be interlocked together to create a flotation device. In such embodiments, a plurality of block molds is interlocked together. Then, in some embodiments, faceplates are attached to the sides of the flotation device that will face the water, thereby preventing water from coming into the flotation device. Then, in other embodiments, faceplates are attached to all of the exterior sides of the flotation device, and a floatable material is introduced to encapsulate the entire structure made from the hollow interconnecting block molds, as the floatable material encapsulates the entire exterior structure of the block molds, with the only faceplates being on the exterior of the structure, as the faceplates are affixed to each of the designed connecting outward protrusions, and further that the center outward protrusions may remain void, as the hollow volume space within all of the hollow bodies of all of the connected block molds, and all of the hollow spaces of the outward protrusions share the same common air space with the hollow block mold structure, as they are all physically connected together,

The flotation devices comprised of hollow interconnecting block molds can vary in size. In some embodiments, the flotation device is a raft designed to hold one or more people. In other embodiments, the flotation device is a floating garden, in further embodiments, the block mold structure is a personal floatation device.

### Gardens and Habitats

In another embodiment, the hollow interconnecting block molds with outward protrusions of this disclosure are comprised of non-toxic materials. In such embodiments, a plurality of interconnecting molds can be interlocked together to create gardening structures, as the block molds are connected and as water pipes travel through the block mold structure through the center outward protrusions, as they are aligned and the connecting outward protrusions have affixed the block molds together, having the ability to produce vertical gardens, raised gardens, and gardens that have block molds with hollow bodies that can capture rain water, and allow the water to travel to all of the connected block molds, as the center outward protrusions can have water pipes in them, but also have some void space between the pipe passing through the center outward protrusion and the inside diameter of the center outward protrusion, and where the water may pool inside each of the hollow bodies of the block mold, where the soil mixture may provide a base for the roots of plants to thrive, whereas the plants have their roots inside the hollow bodies of the block molds, the stems and leaves project outward of the center outward protrusions, where they may experiences photo synthesis and thrive.

In another embodiment, the hollow interconnecting block molds with outward protrusions of this disclosure are comprised of non-toxic materials. In such embodiments, a plurality of interconnecting molds can be interlocked together to create artificial coral reefs, to help preserve marine life, as the hollow bodies of the block molds can be filled with the proper nourishment to attract life that will multiply and thrive, so that particular life form can be a source of food to allow another particular life form to thrive, creating habitats to help preserve a necessary element of the human food chain.

In another embodiment, the hollow interconnecting block molds with outward protrusions of this disclosure are comprised of non-toxic materials. In such embodiments, a plurality of interconnecting molds can be interlocked together to create aquariums, as the block molds made of glass or plastic can connect together and make a habit-trail for fish and aquatic life, as the fish may travel to the hollow bodies of the block mods, as they travel through the center outward protrusions, connected together with connecting couplings.

In another embodiment, the hollow interconnecting block molds with outward protrusions of this disclosure are comprised of non-toxic materials. In such embodiments, a plurality of interconnecting molds can be interlocked together to create a toy, allowing children to connect the block molds together and install faceplates, creating their own engineered designs.

### EQUIVALENTS

Those skilled in the art will recognize, or be able to ascertain, using no more than routine experimentation, numerous equivalents to the specific embodiments described specifically in this disclosure. Such equivalents are intended to be encompassed in the scope of this disclosure and the following claims.

1. An 8-inch cuboid hollow interconnecting block mold with a proximate ¼″ wall thickness, comprised of plastic materials, comprising an interior hollow center space within the confines of the interior faces of the 8-inch cuboid block mold, whereas each exterior face of the block mold comprises one center outward protrusion of approximate 4½″ in diameter and 2″ long, proximate the center of each exterior face, and four connecting outward protrusions of a proximate ¾″ in diameter and 2″ long, proximate each vertex of each exterior face, wherein the outward protrusions are comprised of the same proximate materials and have the same proximate wall thickness as PVC Pipe, whereas each hollow outward protrusion rises perpendicularly from the exterior face to the rim of each outward protrusion, wherein each rim may be sealed with a rim membrane to protect the interior hollow center space.

2. The hollow interconnecting block molds of claim 1, further comprising a plurality of face interconnecting outward protrusions proximate to each face vertex.

3. The hollow interconnecting block molds of claim 1, wherein each face further comprises four face edges and one or more face edge outward protrusions proximate to one or more of the face edges.

4. The hollow interconnecting block molds of claim 1, further comprising at least one faceplate.

5. The hollow interconnecting block molds of claim 4, wherein at least one faceplate is connected to one face of any face or base of the block mold.

6. The hollow interconnecting block molds of claim 4, wherein the first hollow interconnecting block mold comprises a third face, the method further comprising attaching a faceplate to the third face.

7. The hollow interconnecting block molds of claim 1, wherein at least two faces comprise a face center outward protrusion and at least one connecting outward protrusion proximate each vertex of the at least two faces comprising a face center outward protrusion.

8. The hollow interconnecting block molds of claim 1, wherein the hardware is selected from the group consisting of a bolt, a washer, a nut, threaded rod, a plastic insert, metal insert, rubber sleeve, and a toggle bolt.

9. The hollow interconnecting block mold structure of claim 1, further comprising one or more pipes within the center outward protrusions of one or more hollow interconnecting block molds.

10. The hollow interconnecting block mold structure of claim 1, further comprising one or more wires within the center outward protrusions of one or more hollow interconnecting block molds.

11. The hollow interconnecting block mold structure of claim 1, further comprising conduit within the center outward protrusions of one or more hollow interconnecting block molds.

12. The hollow interconnecting block mold structure of claim 1, wherein the block molds are comprised of a material, or materials selected from the group consisting of cementitious materials, cement, metal, plastic, glass, cloth, thread, rubber, sponge, liquid, gas, and earthen materials.

13. The hollow interconnecting block mold structure of claim 1, wherein the structure is encapsulated with a material, or a combination of materials selected from the group consisting of plastic, sand, cement, water, gravel, animal food, plant food, metal, rock, insulation, or a combination thereof, after being secured into a container, to manufacture a hollow interconnecting block.

14. The hollow interconnecting block mold structure of claim 1, wherein the hollow interconnecting block molds are connected together to form a structure, such as a seawall, wall, foundation, garden, artificial coral reef, or flotation device.

15. The hollow interconnecting block mold structure of claim 1, further comprising gasket materials to be installed or administered around the outward protrusions of one or more hollow interconnecting block molds.

16. A method of manufacturing a hollow interconnecting block mold, whereas the proximate 8-inch cuboid hollow interconnecting block mold is comprised of six separate pieces, comprising six proximate 8″×8″ squares having of a proximate uniform thickness, comprising a center outward protrusion proximate each center of each proximate 8″×8″ exterior face of each square, and one connecting outward protrusion proximate each vertex of each proximate 8″×8″ exterior face of each square, whereas each outward protrusion extends perpendicularly from the exterior face of the proximate 8″×8″ square to a distance of a proximate 2-inches, whereas each proximate 2-inch outward protrusion comprises a rim at the end of the outward protrusions, whereas a rim membrane may be affixed to protect the interior hollow center space of the block mold upon assembly, whereas the 8″×8″ squares may be glued, screwed, bracketed, or fastened together a number of ways, including customized sides for quality edges.

17. A hollow interconnecting block mold, comprised of at least five faces, wherein at least three faces comprise at least three parallelogram faces, one top end base face, and one bottom end base face, wherein there is a uniform wall thickness between the interior faces and exterior faces of a proximate ¼-inches thick for all the faces of the block mold, whereas the hollow interconnecting block mold is named after the shape of the end base faces, wherein the interior hollow center space inside the body of the block mold is encapsulated by the interior faces of the block mold, whereas at least two exterior faces comprises at least one center outward protrusion and one connecting outward protrusion, whereas human hands can enter into the interior hollow center space from the center outward protrusions, whereas two block molds may be assembled together using mechanical hardware, by manipulating threaded rod into and through the connecting outward protrusions of two block molds while keeping the rims of the center outward protrusions of each mold proximate to each other, whereas the threaded rod passes through the washers and nuts are wound on to each end of the threaded rod.
